(19) United States
(12) Patent Application Publication
(10) Pub. No.: US 2004/0204926 A1
(43) Pub. Date: Oct. 14, 2004

(54) Method, system and computer program product for verification of the accuracy of numerical data in the solution of a boundary value problem

(76) Inventors: Pekka Neittaanmaki, Seminaarinkatu (FI); Sergey Repin, St.-Petersburg (RU); Sergey Korotov, Tervalankatu (FI)

Correspondence Address: Christopher J. Fildes, Fildes & Outland, P.C., Suite 2, 20916 Mack Avenue, Grosse Pointe Woods, MI, 48236, US

(21) Appl. No.: 10/818,205

(22) Filed: Apr. 5, 2004

(30) Foreign Application Priority Data
Apr. 11, 2003 (FI) 20030550

(51) Int. Cl. G06F 17/10

(52) U.S. Cl. 703/2

(57) ABSTRACT

The present invention relates to an estimation of computational errors appearing in the finite element calculations, particularly to method, system and program product for verification of the accuracy of numerical data measured in terms of problem-oriented criteria, where the numerical data are computed in the process of solution of a boundary value problem. In addition to the primal problem a certain adjoin problem is formed and solved. The method is based on two principles:

(a) the original and adjoint problems are solved on non-coinciding meshes, and

(b) the term presenting the product of errors arising in the primal and adjoint problems is estimated by the gradient recovery technique.

### BACKGROUND OF THE INVENTION

1. Field of the Invention

The present invention relates to an estimation of computational errors appearing in the finite element calculations, particularly to method, system and program product for verification of the accuracy of numerical data measured in terms of problem-oriented criteria, where the numerical data are computed in the process of solution of a boundary value problem, which is defined by one or several partial differential equations (PDEs), governing an unknown physical quantity in a solution domain, and boundary conditions.

2. Description of the Prior Art

Finite Element Method (FEM) is a very powerful and nowadays the most popular numerical method for solving the partial differential equations (PDEs). The concept of FEM consists of discretizing the solution domain into a set (called the mesh) consisting of small elements with simple shapes. The mesh is characterized by a number of degrees of freedom (DOF), we denote it by n in the text. In structural mechanics, the DOF represent the virtual displacements on points (nodes), where the (finite) elements are constructed. The finite element (FE) solution is built from the solution of a system of n linear algebraic equations. Engineers have years of experience and practice in the finite element calculations and analysis. When designing e.g. a new structure, the mechanical engineer can use the FEM to calculate a tension distribution in a structure (e.g., in frame, crankshaft or beam). Normally, there are a few critical areas to be carefully analysed. An ordinary approach is to perform computations on more and more dense mesh, hoping that the computed approximate solutions are becoming more and more closer to the exact solution (which is normally not known at all). But the closeness of such calculated approximations to the exact solution can be illusory in many respects, and the computed data (numbers) can be far from the truth, thus being rather unreliable and useless. A solution of this problem is an availability of certain tools (software) for the engineers and designers for explicit control of the error between the exact solution and the computed approximation. A development of theoretical backgrounds and various techniques for building of such tools (called a priori error estimates) has been a main topic in the modern numerical analysis last two decades. For the finite element methods, such a priori error estimates are usually obtained either by estimating a weak norm of the residual [1] or by using special postproces sing procedures [5]. For the Galerkin (finite element) approximations of linear elliptic problems, they estimate the error in the global (energy) norm and also provide an error indicators that are further used in various mesh adaptive procedures. Global error estimates give a general presentation on the quality of an approximate solution and a stopping criteria. However, from the viewpoint of engineering purposes, such an information is often not sufficient. In many cases, the engineers are interested not in the value of the total error, but, as was mentioned above, in errors over certain critical areas: subdomains, lines, or at special points. A possible way of estimating such type of errors is to introduce a certain linear functional l associated with a critical area, where l(u) is often called as a problem-oriented criterion or “quantity of interest”, and to obtain an estimate for the value of l(u−v), where u is the exact solution and v is the approximate one. Known methods [2] find estimates for l(u−uₕ) for the Galerkin approximations uₕ by employing an auxiliary (often called as adjoint) problem, whose right-hand side is formed by the functional l. If the Galerkin approximation of the adjoint problem is computed on the same mesh as uₕ, then the functional value l(u−uₕ) is expressed via a certain integral functional, which can be estimated by using, e.g., the “equilibrated residual method” [4]. However, all the results obtained by now are rather far from being satisfactory.

What is needed is a reliable and effective method, system and program product for verification of the accuracy of numerical data measured in terms of problem-oriented criteria.

### OBJECTS AND SUMMARY OF THE INVENTION

We present a new method for estimation of the “quantities of interest” [3] as well as a system and a program product for implementing the method. It is based on two principles:

(a) the original and adjoint problems are solved on non-coinciding meshes, and

(b) the term presenting the product of errors arising in the primal and adjoint problems is estimated by the gradient recovery technique widely used in various applied problems.

These features differ our method from others, who are usually assumed that the Galerkin approximations of the primal and auxiliary (adjoint) problems should be computed on the same finite dimensional subspaces.

Using the fact of non-coincidence of the meshes, we obtain a new estimator which is a sum of two terms (E₀) and (E₁), where the first term (E₀) contains the major part of the “quantity of interest”, but vanishes whenever the mesh coincide. The effectivity of the method is demonstrated for one- and two-dimensional problems, part of which is presented in the text later on.

In the preferred embodiment the estimator (E) is a sum of the first term (E₀) and the second term (E₁), where

the first term (E₀) is computable as a sum of three parts, where the first part is an integral over the solution domain (Ω) of a product of the source function (f) and the second approximation (v_{τ}), the second part is an integral over the Neumann boundary (Γ₂) of a product of the boundary function (g) and the second approximation (v_{τ}), and the third part is a minus integral over the solution domain (Ω) of an energy scalar products of the gradients of the first (uₕ) and the second (v_{τ}) approximations, and

the second term (E₁) is the integral over the solution domain (Ω) of the energy scalar product of two vector-functions, where the first vector-function is the difference between the gradient of the first approximation (uₕ) and the averaged gradient of the first approximation (uₕ), and the second vector-function is the difference between the gradient of the second approximation (v_{τ}) and the averaged gradient of the second approximation (v_{τ}).

The effectivity of the method proposed, strongly increases when one is interested not in a single solution of the primal problem for a concrete data, but analyzes a series of approximate solutions for a certain set of boundary conditions and various right-hand sides (and such a situation is very typical in the engineering design, when it is necessary to model the behaviour of a construction for various working regimes). In this case, the adjoint problem must be solved only once for each “quantity of interest”, and its solution can be further used in testing the accuracy of approximate solutions of various primal problems (i.e. with various source functions).

The present invention can be implemented using a computer. An exemplary computer includes one or more processors, memory (like ROM, RAM and hard-drive), input device (like keyboard, floppy disk drive) and output device (like display and printer). Method can be implemented directly for any software using FEM as a computational tool. Without any new software the first and second approximations as well as computing the estimator must be executed separately. We present new software, which includes all necessary routines and interface for an implementation.

### BRIEF DESCRIPTION OF THE DRAWINGS

In the following, the invention is examined with the aid of the accompanying drawings and examples. In the drawings illustrates a solution domain with basic denotations for the diffusion type problem

FIG. 1 illustrates a solution domain with basic denotations

FIG. 2 illustrates a part of standard finite element mesh and a patch associated with one of its nodes

FIG. 3 illustrates an elastic body as a solution domain with basic denotations for the linear elasticity problem

FIG. 4 illustrates main desktop of CHECKER-software

FIG. 5 illustrates setting the domain and the zone of interest in Matlab® PDE Toolbox

FIG. 6 illustrates the export window of Matlab® PDE Toolbox for exporting domain data and formula data for the primal problem to CHECKER-software

FIG. 7 illustrates setting the boundary conditions in Matlab® PDE Toolbox

FIG. 8 illustrates the export window for exporting data of the zone of interest and boundary conditions to CHECKER-software

FIG. 9 illustrates the process of solving the primal problem in CHECKER-software

FIG. 10 illustrates the process of solving the auxiliary (adjoint) problem in CHECKER-software

FIG. 11 illustrates the process of solving the auxiliary problem with a local refinement in the zone of interest in CHECKER-software

FIG. 12 illustrates CHECKER desktop with visible results of

FIG. 13 illustrates a block diagram of CHECKER-software with short step references A-E

FIG. 14 illustrates the source function of the one-dimensional test problem

FIG. 15 illustrates the exact and the approximate solutions and the zone of interest of the one-dimensional test problem

FIG. 16 illustrates the behaviour of the effectivity index in various mesh parameters

FIG. 17 illustrates the meshes Tₕ and T_{τ} for the one-dimensional test problem

FIG. 18 illustrates a flowchart for computing an approximation and an error estimation

### DETAILED DESCRIPTION OF THE PREFERRED EMBODIMENTS

Table of Contents

I. Model Theory

A. Introduction

B. Problem Formulation—Diffusion-Type Problem

1. Mathematical model

2. Finite element solution

3. Problem-oriented criterion

4. Error estimation

5. Technique for the error estimation in terms of problem-oriented criteria

6. Auxiliary problem and its finite element solution

7. Gradient averaging procedures

8. Formula for calculation of the estimator

9. Error estimation algorithm

C. Problem Formulation—Linear Elasticity Problem

1. Mathematical model

2. Finite element solution

3. Problem-oriented criterion

4. Error estimation

5. Technique for the error estimation in terms of problem-oriented criteria

6. Auxiliary problem and its finite element solution

7. Tensor averaging procedures

8. Formula for calculation of the estimator

9. Error estimation algorithm

D. Advantages Of The Technique

II. Implementation In A System

A. Introduction

B. Presentation of Software Product with a Model

III. Model Example—One Dimensional Case

I Model Theory

### A—Introduction

The method presented below is designed to verify the accuracy of FE approximations, measured in terms of “problem-oriented” criterion that can be chosen by users. The method is applic able to various problems in mechanics and physics embracing diffusion and linear elasticity problems. It can be easily coded and attached as an independent programme-checker to the most of existing educational and industrial codes.

### B—Problem Formulation Part—Diffusion-Type Problem

B.1 Mathematical Model

We consider physical process that can be formally modelled in the form of a boundary value problem of elliptic type (BVP) as follows referring to FIG. 1: Find a function u=u(x₁, . . . ,x_{d}) of d variables x₁, . . . ,x_{d} such that

$$- {\sum }_{i , j = 1}^{d} \frac{\partial }{\partial {x}_{i}} ( {a}_{ij} \frac{\partial u}{\partial {x}_{j}} ) = f in Ω , \qquad ( 1 )$$

u=u₀ on Γ₁, (2a)

$${\sum }_{i , j = 1}^{d} {a}_{ij} \frac{\partial u}{\partial {x}_{j}} {n}_{i} = g on {Γ}_{2} . \qquad ( 2 b )$$

In the above, relation (1) is a process governing equation in the solution domain Ω⊂R^{d}, where aᵢⱼ=aᵢⱼ(x₁, . . . ,x_{d}),i,j=1, . . . ,d, are the given coefficients of the problem that usually describe the diffusion properties of the respective media. This model also applies to stationary magnetic, electric, and temperature field, or some phenomena in the linear elasticity or fluid flow. The function f=f(x₁, . . . ,x_{d}) can be viewed as a given source function. The coefficients are assumed to be bounded functions and function f is assumed to be square summable. Further, relations (2a) and (2b) are boundary conditions on the boundary Γ of Ω, more precisely, they prescribe a behaviour of the solution and its derivatives on two nonintersecting boundary parts Γ₁ and Γ₂, respectively, i.e., Γ=Γ_{1∪Γ}₂. The function u₀=u₀(x₁, . . . ,x_{d}) belongs to the natural energy class of the problem and g=g(x₁, . . . ,x_{d}) is a square summable function, symbol nᵢ denotes the i-th component of the outward normal vector n=n(x₁, . . . ,x_{d}) to the boundary Γ, i.e., n=[n₁, . . . ,n_{d}]^{T} (see FIG. 1).

The above assumptions are not restrictive and cover the bulk of practically meaningful cases.

B.2 Finite Element Solution of (1)-(2)

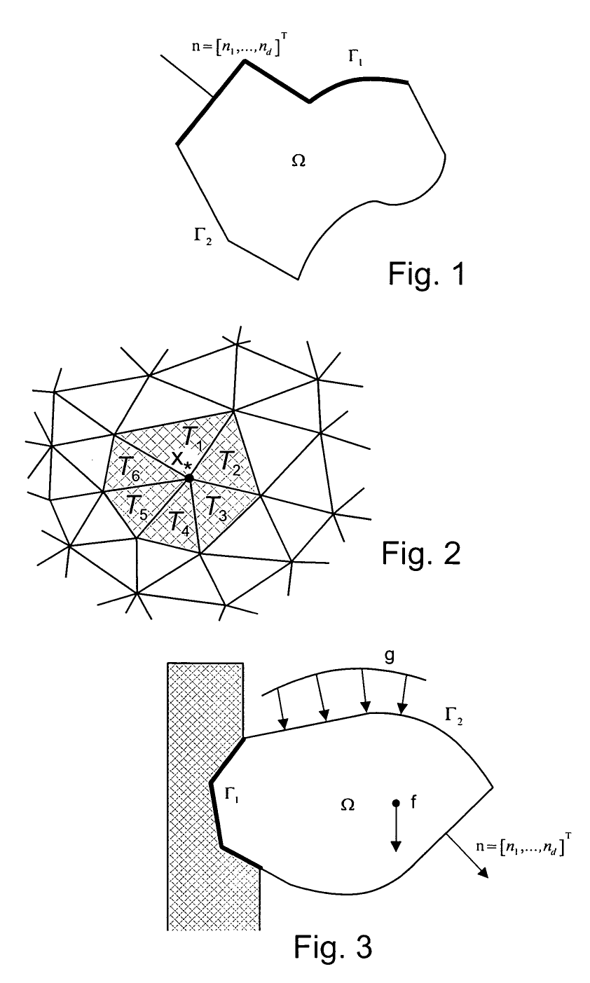

Let Vₕ be a finite-dimensional space constructed by means of a selected set of finite element trial functions defined on a standard finite element mesh Tₕ (called the first mesh) over the solution domain Ω, see FIG. 2. We notice that space Vₕ is chosen so that its functions wₕ vanish on Γ₁.

The first approximation for problem (1)-(2) is defined as a function

uₕ=uₕ(x₁, . . . ,x_{d})εVₕ+u₀,

such that

$${\int }_{Ω} {\sum }_{i , j = 1}^{d} {a}_{ij} \frac{\partial {u}_{h}}{\partial {x}_{j}} \frac{\partial {w}_{h}}{\partial {x}_{i}} ⅆ x = {\int }_{Ω} {fw}_{h} ⅆ x + {\int }_{{Γ}_{2}} {gw}_{h} ⅆ s ∀ {w}_{h} ∈ {V}_{h} . \qquad ( 3 )$$

B.3 Problem-Oriented Criterion

Users are often interested not only in the overall error e=u−uₕ, but also in its local behaviour, e.g., in a certain subdomain ω⊂Ω. One way to get information about the local behaviour of u−uₕ is to measure the error in terms of specially selected problem-oriented criteria on “quantity of interest”. One of the most typical criteria of such a type is presented by the integral

$${\int }_{Ω} ϕ ( u - {u}_{h} ) ⅆ x , \qquad ( 4 )$$

where φ=φ(x₁. . . ,x_{d}) is a selected weight function vanishing outside of the zone of interest.

B.4 Error Estimation

Error estimators are intended to show the value of the error in the subdomain, which is the most interesting for an engineer. Also they suggest information on that how to improve an approximate solution computed if the accuracy obtained is not sufficient. At this point we note that our estimator is given by the integral whose integrand could serve as the respective indicator. Namely, if the accuracy achieved is not sufficient, then additional degrees of freedom (new elements) must be added in those parts of the solution domain, where the integrand is excessively high.

B.5 Technique for the Error Estimation in Terms of Problem Oriented Criteria

To present the technique for estimation of criterion (4), we describe two technical problems that must be previously solved. They consist of finding an approximate solution of an auxiliary problem (so-called adjoint problem) and making a certain post-processing of this solution vₒ, and also making a post-processing of the finite element approximation uₕ.

B.6 Auxiliary Problem and its Finite Element Solution

Let V_{τ} be the second finite-dimensional space constructed by means of a selected set of finite element trial functions on another standard finite element mesh T_{τ} (called the second mesh) over the solution domain Ω. We notice that space V_{τ} is chosen so that its functions wᵣ vanish on Γ, and also that T_{τ} need not to coincide with Tₕ, see FIG. 2. A part of standard finite element mesh and a patch associated with node.

Consider the auxiliary finite-dimensional problem as follows: Find a function

v_{τ}=v_{τ}(x₁, . . . , x_{d})δV_{τ},

such that

$${\int }_{Ω} {\sum }_{i , j = 1}^{d} {a}_{ji} \frac{\partial {v}_{τ}}{\partial {x}_{j}} \frac{\partial {w}_{τ}}{\partial {x}_{i}} ⅆ x = {\int }_{Ω} ϕ {w}_{τ} ⅆ x ∀ {w}_{τ} ∈ {V}_{τ} . \qquad ( 5 )$$

B.7 Gradient Averaging Procedures

On the first mesh Tₕ, we define the gradient averaging transformation Gₕ mapping the gradient of the finite element approximation uₕ

$$∇ {u}_{h} = {[ \frac{\partial {u}_{h}}{\partial {x}_{1}} , … , \frac{\partial {u}_{h}}{\partial {x}_{d}} ]}^{T} , \qquad ( 6 )$$

which is constant over each element of the finite element mesh, into a vector-valued continuous piecewise affine function

Gₕ(∇uₕ)=[Gₕ¹(∇uₕ), . . . , Gₕ^{d}(∇uₕ)]^{T}, (7)

by setting each its nodal value as the mean value of ∇uₕ on all elements of the patch P(xₒ) associated with corresponding node xₒ in the mesh Tₕ.

More precisely, let

$$\frac{\partial {u}_{h}}{\partial {x}_{i}} {\vert}_{{T}_{k}}$$

denote the value of i-th coordinate of gradient ∇uₕ over triangle Tₖ, let xₒ be one of nodes of finite element mesh Tₕ, and let T₁, . . . , T_{N}_{ₓₒ} be elements of the mesh having node xₒ as one of their vertices. The union of such elements is called the patch and denoted as P(xₒ). (Thus, in terms of FIG. 2, the patch consists of six triangles, i.e., Nₓ=6.) Then, we define

$$\begin{matrix}{G}_{h}^{i} ( ∇ {u}_{h} ) ( {x}_{*} ) = \frac{1}{{N}_{{x}_{*}}} {\sum }_{{T}_{k} ∈ P ( {x}_{*} )}^{} \frac{\partial {u}_{h}}{\partial {x}_{i}} {\vert}_{{T}_{k}} , i = 1 , … , d , \\ or & ( 8 a ) \\ {G}_{h}^{i} ( ∇ {u}_{h} ) ( {x}_{*} ) = \frac{1}{{measT}_{1} + … + {measT}_{{N}_{{x}_{*}}}} {\sum }_{{T}_{k} ∈ P ( {x}_{*} )}^{} {measT}_{k} \cdot \frac{\partial {u}_{h}}{\partial {x}_{i}} {\vert}_{{T}_{k}} , i = 1 , … , d , & ( 8 b )\end{matrix}$$

where the symbol meas denotes the area of corresponding triangle.

Having Gₕ(∇uₕ) defined at all nodes of the mesh Tₕ, we uniquely define continuous piecewise affine function Gₕⁱ(∇uₕ) over the whole domain Ω. In this way, the vector-valued continuous piecewise affine function Gₕ(∇uₕ) in (7) is built. Similarly, on T_{τ}, we define the gradient averaging transformation G_{τ} mapping the gradient of the finite element approximation V_{τ}

$$∇ {v}_{τ} = {[ \frac{\partial {v}_{τ}}{\partial {x}_{1}} , … , \frac{\partial {v}_{τ}}{\partial {x}_{d}} ]}^{T} , \qquad ( 9 )$$

which is constant over each element of the finite element mesh, into a vector-valued continuous piecewise affine function

G_{τ}(∇v_{τ})=[G_{τ}¹(∇v_{τ}), . . . ,G_{τ}^{d}(∇v_{τ})]^{T}, (10)

by setting each its nodal value as the mean value of ∇v_{τ} on all elements of the patch P(xₒ) associated with corresponding node xₒ in the mesh T_{τ}.

More precisely, let

denote the value of i-th coordinate of gradient ∇v_{τ} over triangle Tₖ, let xₒ be one of nodes of finite element mesh T_{τ}, and let T₁, . . . ,

$$\begin{matrix}{E}_{0} ( {u}_{h} , {v}_{τ} ) = {\int }_{Ω} f {v}_{τ} ⅆ x + {\int }_{{Γ}_{2}} {gv}_{τ} ⅆ s - {\int }_{Ω} {\sum }_{i , j = 1}^{d} {a}_{ij} \frac{\partial {u}_{h}}{\partial {x}_{j}} \frac{\partial {v}_{τ}}{\partial {x}_{i}} ⅆ x , \\ and & ( 13 ) \\ {E}_{1} ( {u}_{h} , {v}_{τ} ) = {\int }_{Ω} {\sum }_{i , j = 1}^{d} {a}_{ij} ( \frac{\partial {u}_{h}}{\partial {x}_{j}} - {G}_{h}^{j} ( ∇ {u}_{h} ) ) ( \frac{\partial {v}_{τ}}{\partial {x}_{i}} - {G}_{τ}^{i} ( ∇ {v}_{τ} ) ) ⅆ x . & ( 14 )\end{matrix}$$

T_{N}_{ₓₒ} be elements of the mesh having node xₒ as one of their vertices. The respective patch is denoted as P(xₒ). Then

$$\begin{matrix}{G}_{τ}^{i} ( ∇ {v}_{τ} ) ( {x}_{o} ) = \frac{1}{{N}_{{x}_{o}}} {\sum }_{{T}_{k} ∈ P ( {x}_{o} )}^{} \frac{\partial {v}_{τ}}{\partial {x}_{i}} {\vert}_{{T}_{k}} , i = 1 , … , d . \\ or & ( 11 a ) \\ {G}_{τ}^{i} ( ∇ {v}_{τ} ) ( {x}_{o} ) = \frac{1}{{measT}_{1} + … + {measT}_{{N}_{{x}_{o}}}} {\sum }_{{T}_{k} ∈ P ( {x}_{o} )}^{} {measT}_{k} \cdot \frac{\partial {v}_{τ}}{\partial {x}_{i}} {\vert}_{{T}_{k}} , i = 1 , … , d . & ( 11 b )\end{matrix}$$

Having G_{τ}ⁱ(∇v_{τ})(xₒ) at all nodes xₒ, we uniquely define continuous piecewise affine function G_{τ}ⁱ(∇v_{τ}) over the whole domain Ω. In this way, the vector-valued continuous piecewise affine function G_{τ}(∇v_{τ}) in (10) is built.

Such averaging transformations are widely used in the finite element calculations. Usually they lead to computationally inexpensive algorithms.

B.8 Formula for Calculation of the Estimator

Our method estimates the quantity (4) by the quantity E(uₕ,v_{τ}) presented by the following formula:

E(uₕ,v_{τ}):=E₀(uₕ,v_{τ})+E₁(uₕ,v_{τ}), (12)

where

$$\frac{\partial {v}_{τ}}{\partial {x}_{i}} {\vert}_{{T}_{k}}$$

The functional E(uₕ,v_{τ}) is directly computable once the approximations uh and v, are found.

B.9. Error Estimation Algorithm

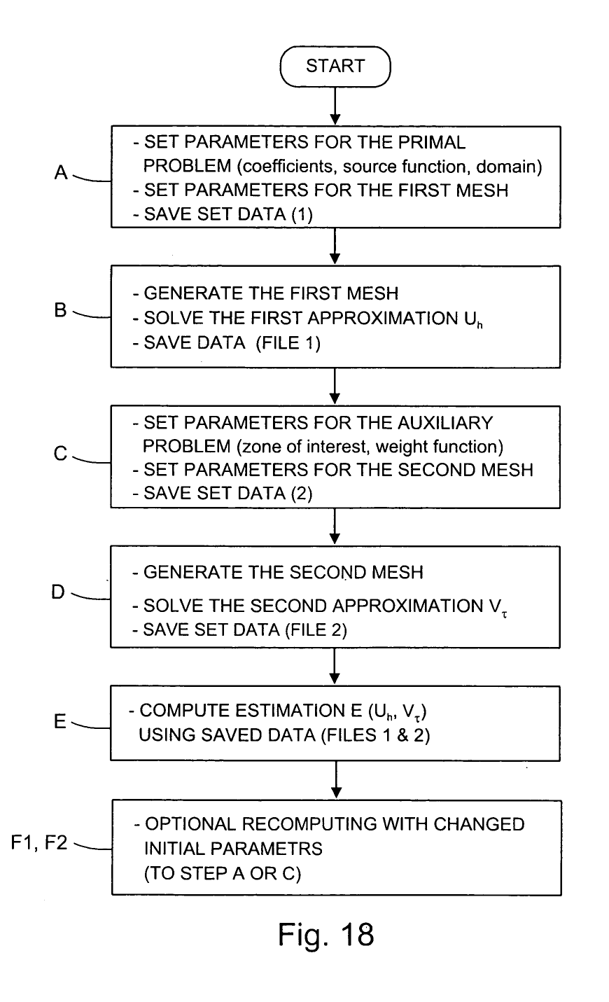

Step 1: Pose a problem of type (1)-(2a,b); (Step A in FIGS. 13 and 18)

Step 2: Find uₕ in (3); (Step B)

Step 3: Select criterion (4), i.e. subdomain ω and function φ; (Step C)

Step 4: Solve auxiliary problem (5) and find v_{τ}; (Step D)

Step 5: Construct/form Gₕ(∇uₕ) by (8a) or (8b); (Estimation

Step 6: Construct/form G_{τ}(∇v_{τ}) by (11a) or (11b); (Estimation)

Step 7: Compute E₀(uₕ,v_{τ}); (Estimation)

Step 8: Compute E₁(uₕ,v_{τ}); (Estimation)

Step 9: Compute E(uₕ,v_{τ}); (Estimation)

(Steps 5-9 correspond step E in FIGS. 13 and 18.

Optional step 10: change initial parameters. (Step F1 or F2)

### C—Problem Formulation—Linear Elasticity Problem

C.1 Mathematical Model

We consider mechanical problem of elasticity that can be formally presented in the form of a system of linear elasticity equations as follows: Find a vector-function (called the displacement) u=u(x₁, . . . ,x_{d})=[u₁, . . . ,u_{d}]^{T} of d variables x₁, . . . ,x_{d} such that, for i=1, . . . ,d

$$- {\sum }_{j , k , l = 1}^{d} \frac{\partial }{\partial {x}_{j}} ( {L}_{ijkl} {ϵ}_{kl} ( u ) ) = {f}_{i} in Ω , \qquad ( 1 )$$

uᵢ=u₀ⁱ on Γ₁, (2a)

$${\sum }_{j , k , l = 1}^{d} {n}_{j} {L}_{ijkl} {ϵ}_{kl} ( u ) = {g}_{i} on {Γ}_{2} . \qquad ( 2 b )$$

In the above, relation (1) is a governing system of equations in the solution domain (body) Ω⊂R^{d}, where Lᵢⱼₖₗ=Lᵢⱼₖₗ(x₁, . . . ,x_{d}),i,j=1, . . . ,d, are the given coefficients of the problem that usually describe the elastic properties of the respective body, and the vector-function f=f(x₁, . . . ,x_{d})=[f₁, . . . f_{d}]^{T} represents a given body force. The coefficients are assumed to be bounded functions and function f is assumed to be square summable. In addition, the coefficients satisfy the following symmetry conditions

Lⱼᵢₖₗ=Lᵢⱼₖₗ=Lₖₗᵢⱼ, i,j,k,l=1, . . . ,d. (3)

Further, the functions εᵢⱼ(u),i,j=1, . . . ,d, are defined as follows

$${ϵ}_{ij} ( u ) = \frac{1}{2} ( \frac{\partial {u}_{i}}{\partial {x}_{j}} + \frac{\partial {u}_{j}}{\partial {x}_{i}} ) , \qquad ( 4 )$$

they form the so-called small strain (or deformation) tensor (d×d matrix) ε(u).

The relations (2a) and (2b) are boundary conditions on the boundary Γ of Ω, more precisely, they prescribe a behaviour of the solution and its derivatives on two nonintersecting boundary parts Γ₁ and Γ₂, respectively, i.e., Γ=Γ₁∪Γ₂. The vector-functions u₀=u₀(x₁, . . . ,x_{d})=[u₀¹, . . . ,u₀^{d}]^{T} represents the external force and belongs to natural energy class of the problem and g=g(x₁, . . . ,x_{d})=[g₁, . . . ,g_{d}]^{T} is a square summable function. The function g represents the external force. The symbol nᵢ denotes the i-th component of the outward normal vector n=n(x₁, . . . ,x_{d}) to the boundary Γ, i.e., n=[n₁, . . . ,n_{d}]_{T} (see FIG. 3).

Above assumptions are not restrictive and cover the bulk of practically meaningful cases.

C.2 Finite Element Solution of (1)-(2)

Let Vₕ be a finite-dimensional space constructed by means of a selected set of finite element trial (d-dimensional) vector-functions defined on commonly-used finite element mesh Tₕ over Ω. We notice that space Vₕ is chosen so that its functions wₕ vanish on Γ₁.

The finite element approximation for problem (1)-(2) is defined then as a vector-function such that

uₕ=uₕ(x₁, . . . ,x_{d})=[uₕ¹, . . . ,uₕ^{d}]^{T}εVₕ+u₀,

such that

$${\int }_{Ω} {\sum }_{i , j , k , l = 1}^{d} {L}_{ijkl} {ϵ}_{ij} ( {u}_{h} ) {ϵ}_{kl} ( {w}_{h} ) ⅆ x = {\int }_{Ω} f \cdot {w}_{h} ⅆ x + {\int }_{{Γ}_{2}} g \cdot {w}_{h} ⅆ s ∀ {w}_{h} ∈ {V}_{h} , \qquad ( 5 )$$

where the symbol “dot” denotes the standard vector multiplication.

C.3 Problem-Oriented Criterion

Users are often interested not only in the overall error e=u−uₕ, but also in its local behaviour, e.g., in a certain subdomain ∩⊂Ω.

One way to get an information about the local behaviour of u−uₕ is to measure the error in terms of specially selected problem-oriented criteria.

One of the most typical criteria of such a type is presented by the integral

$${\int }_{Ω} Φ \cdot ( u - {u}_{h} ) ⅆ x , \qquad ( 6 )$$

where Φ=Φ(x₁, . . . ,x_{d})=[φ₁, . . . ,φ_{d}]^{T} is a selected vector-function such that Φ vanishes outside of the zone of interest (ω). C.4 Error Estimation

see Section B4.

C.5 Techniques for The Error Estimation in Terms of Problem-Oriented Criteria

To present the techniques for estimation of criterion given by (6), we need first to describe two technical problems, that must be previously solved. They consist of finding an approximate solution of an auxiliary problem and making a certain post processing of solutions of this auxiliary problem and also of finite element approximation uₕ.

C.6 Auxiliary Problem and its Finite Element Solution

Let Vᵣ be another finite-dimensional space constructed by means of a selected set of finite element trial functions on another standard finite element mesh T_{τ} over Ω. We notice that space V_{τ} is chosen so that its functions w_{τ} vanish on Γ, and also that T_{τ} need not to coincide with Tₕ.

Consider the auxiliary finite-dimensional problem as follows: Find a function

v_{τ}=v_{τ}(x₁, . . . ,x_{d})εV_{τ},

such that

$${\int }_{Ω} {\sum }_{i , j , k , l = 1}^{d} {L}_{ijkl} {ϵ}_{ij} ( {v}_{τ} ) {ϵ}_{kl} ( {w}_{τ} ) ⅆ x = {\int }_{Ω} Φ \cdot {w}_{τ} ⅆ x ∀ {w}_{τ} ∈ {V}_{τ} . \qquad ( 7 )$$

C.7 Tensor Averaging Procedures

On Tₕ, we define the tensor averaging transformation Gₕ mapping the tensor of the finite element approximation uh

$$ϵ ( {u}_{h} ) = {[ \frac{1}{2} ( \frac{\partial {u}_{h}^{i}}{\partial {x}_{j}} + \frac{\partial {u}_{h}^{j}}{\partial {x}_{i}} ) ]}_{i , j = 1}^{d} , \qquad ( 8 )$$

which is a constant d×d matrix over each element of the finite element mesh, into a d×d matrix-valued continuous piecewise affine function

Gₕ(ε(uₕ))=[Gₕ^{i,j}(ε(uₕ))]_{i,j=1}^{d}, (9)

by setting each its nodal value as the mean value of ε(uₕ) on all elements of the patch P(xₒ) associated with corresponding node xₒ in the mesh Tₕ.

More precisely, let xₒ be one of nodes of finite element mesh Tₕ, and let T₁, . . . ,

$$\begin{matrix}{G}_{h}^{i , j} ( ϵ ( {u}_{h} ) ) ( {x}_{*} ) = \frac{1}{{N}_{{x}_{*}}} {\sum }_{{T}_{m} ∈ P ( {x}_{*} )}^{} \frac{1}{2} ( \frac{\partial {u}_{h}^{i}}{\partial {x}_{j}} {{\vert}_{{T}_{m}} + \frac{\partial {u}_{h}^{j}}{\partial {x}_{i}} \vert}_{{T}_{m}} ) , \\ or & ( 10 a ) \\ {G}_{h}^{i , j} ( ϵ ( {u}_{h} ) ) ( {x}_{*} ) = \frac{1}{{measT}_{1} + … + {measT}_{{N}_{{x}_{*}}}} {\sum }_{{T}_{m} ∈ P ( {x}_{*} )}^{} {measT}_{m} \cdot \frac{1}{2} ( \frac{\partial {u}_{h}^{i}}{\partial {x}_{j}} {{\vert}_{{T}_{m}} + \frac{\partial {u}_{h}^{j}}{\partial {x}_{i}} \vert}_{{T}_{m}} ) . & ( 10 b )\end{matrix}$$

T_{N} _{_{x.}} form the patch P(xₒ) (cf. FIG. 2). Then, we define for i,j=1, . . . ,d

Having Gₕ^{i,j}(ε(uₕ)) defined at all nodes of the mesh Tₕ, we uniquely define continuous piecewise affine function Gₕ^{i,j}(ε(uₕ)) over the whole domain Ω. In this way, the matrix-valued continuous piecewise affine function Gₕ(ε(uₕ)) in (9) is built. Similarly, on T_{τ}, we define the tensor averaging transformation G_{τ} mapping the tensor of the finite element approximation vᵣ

$$ϵ ( {v}_{τ} ) = {[ \frac{1}{2} ( \frac{\partial {v}_{τ}^{i}}{\partial {x}_{j}} + \frac{\partial {v}_{τ}^{j}}{\partial {x}_{i}} ) ]}_{i , j = 1}^{d} , \qquad ( 11 )$$

which is a d×d constant matrix over each element of the finite element mesh, into a d×d matrix-valued continuous piecewise affine function

G_{τ}(ε(v_{τ}))=[G_{τ}^{i,j}(ε(v_{τ}))]_{i,j=1}^{d}, (12)

by setting each its nodal value as the mean value of ∇v_{τ} on all elements of the patch P(xₒ) associated with corresponding node xₒ in the mesh T_{τ}.

More precisely, let xₒ be one of nodes of finite element mesh T_{τ}, and let T₁, . . . ,

T_{N}_{ₓₒ} form the patch P(xₒ). Then, we define for i, j=1, . . . ,d

$$\begin{matrix}{G}_{τ}^{i , j} ( ϵ ( {v}_{τ} ) ) ( {x}_{o} ) = \frac{1}{{N}_{{x}_{o}}} {\sum }_{{T}_{m} ∈ P ( {x}_{o} )}^{} \frac{1}{2} {( \frac{\partial {v}_{τ}^{i}}{\partial {x}_{j}} \vert}_{{T}_{m}} + \frac{\partial {v}_{τ}^{j}}{\partial {x}_{i}} {\vert}_{{T}_{m}} ) or & ( 13 a ) \\ {G}_{τ}^{i , j} ( ϵ ( {v}_{τ} ) ) ( {x}_{o} ) = \frac{1}{{measT}_{1} + ⋯ + {measT}_{{N}_{{x}_{o}}}} {\sum }_{{T}_{m} ∈ P ( {x}_{o} )}^{} {measT}_{m} \cdot \frac{1}{2} ( \frac{\partial {v}_{τ}^{i}}{\partial {x}_{j}} {\vert}_{{T}_{m}} + \frac{\partial {v}_{τ}^{j}}{\partial {x}_{i}} {\vert}_{{T}_{m}} ) . & ( 13 b )\end{matrix}$$

Having Gᵣ^{i,j}(ε(v_{τ}))(xₒ) at all nodes xₒ, we uniquely define continuous piecewise affine function G_{τ}^{i,j}(ε(v_{τ})) over the whole domain Ω. In this way, the vector-valued continuous piecewise affine function G_{τ}(ε(v_{τ})) in (12) is built.

C.8 Formula for Calculation of the Estimator

Our method estimates the quantity (6) by the quantity E(uₕ,v_{τ}) given by the following formula:

E(uₕ,v_{τ}):=E₀(uₕ,v_{τ})+E₁(uₕ,v_{τ}), (14)

where

$$\begin{matrix}{E}_{0} ( {u}_{h} , {v}_{τ} ) = {\int }_{Ω} f \cdot {v}_{f} ⅆ x + {\int }_{{Γ}_{2}} g \cdot {v}_{τ} ⅆ s - {\int }_{Ω} {\sum }_{i , j , k , l = 1}^{d} {L}_{ijkl} {ϵ}_{ij} ( {u}_{h} ) {ϵ}_{kl} ( {v}_{τ} ) ⅆ x , and & ( 15 ) \\ {E}_{1} ( {u}_{h} , {v}_{τ} ) = {\int }_{Ω} {\sum }_{i , j , k , l = 1}^{d} {L}_{ijkl} ( {ϵ}_{ij} ( {u}_{h} ) - {G}_{h}^{i , j} ( ϵ ( {u}_{h} ) ) ) ( {ϵ}_{kl} ( {v}_{τ} ) - {G}_{τ}^{k , l} ( ϵ ( {v}_{τ} ) ) ) ⅆ x . & ( 16 )\end{matrix}$$

The functional E(uₕ,v_{τ}) is directly computable once the approximations uₕ and v_{τ} are found.

C.9 Error Estimation Algorithm

The algorithm is similar as that one presented in Section B9.

### D—Advantages of the Technique Presented with Respect to Others Available in the Literature

In the available scientific literature, several methods of computer verification of the accuracy of approximate solutions in terms of “problem-oriented” criteria has been presented. The main advantages of our method with respect to others can be summarized as follows:

the estimator contains an extra term, E₀, which is directly computable and contains major part of the error;

the second term is effectively estimated by means of computationally cheap procedure of “gradient-averaging”;

the estimator is valid for a wide spectrum of approximations including the case when the meshes for the original and auxiliary (adjoint) problems are different.

### II Implementation in a System

A Introduction

Now we describe how the method can be implemented in hardware, software, firmware or combinations thereof, particularly in the form of engineering software. Actually, the nature of the proposed methodology allows a development of the program block “CHECKER”, FIG. 13, which can be easily incorporated in or added in some way to the most of the existing commercial software packages using finite element method as a main computational tool (e.g., Matlab®, ADINA®; ANSYS®, MATHCAD®). To illustrate that we shall use the PDE Toolbox of Matlab® package, especially designed for obtaining the numerical solutions for various classes of boundary-value and initial boundary-value problems.

Thus, using the PDE Toolbox subroutines we have developed a new software, which can help the users of Matlab® not only to calculate numerical solutions for the boundary-value problems, but also effectively estimate their accuracy. Naturally all necessary routines could be integrated into one software package.

B Software Product and its Usage

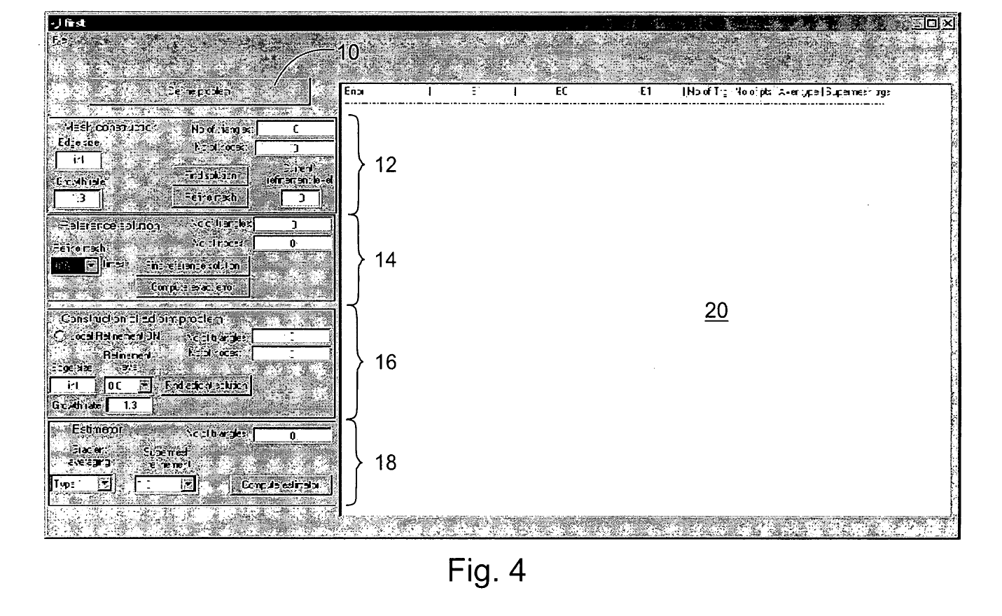

FIG. 4 presents a layout of desktop of the software in a graphical user interface (GUI) and on a display. The desktop (control panel) contains six main blocks: “Define problem”—block 10, “Mesh construction”—block 12, “Reference solution”—block 14, “Construction of adjoint problem”—block 16, “Estimator”—block 18, “Table”—block 20. The software works in a standard PC having processing unit, program and data memory (RAM and hard disk), keyboard, mouse and display. The operating system is Microsoft® Windows, but the software can be implemented in other operating systems, too.

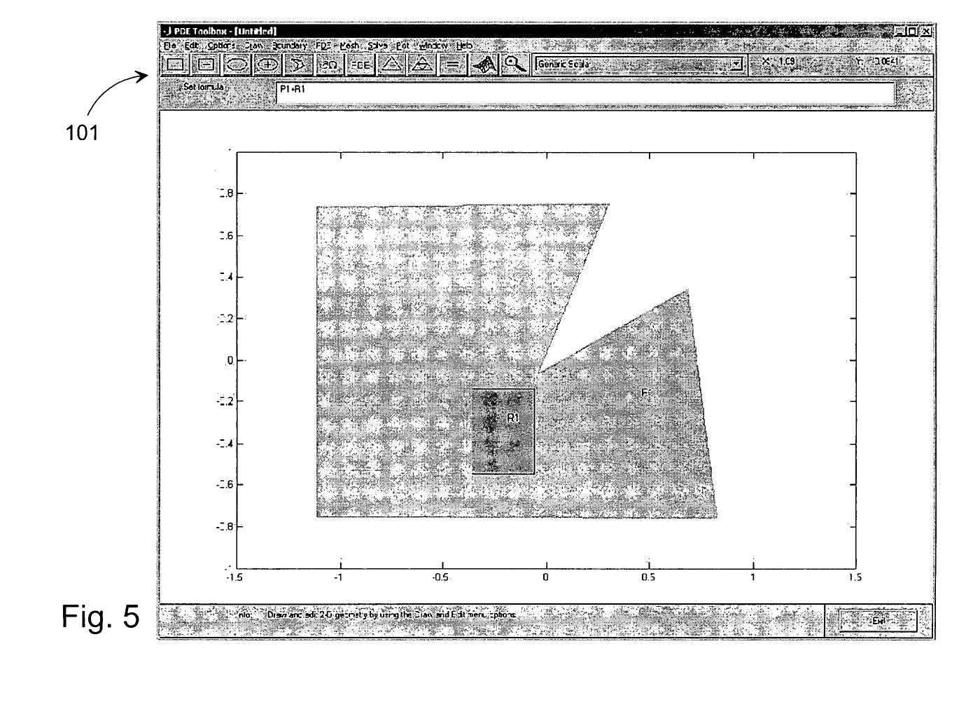

Block 10 calls the PDE Toolbox main window (FIG. 5) for setting the problem: defining the solution domain, zone of interest, boundary conditions, coefficients, source function, which are exported later to our software, step A in FIG. 18.

Block 12 is used for a construction of the first mesh using mesh specification parameters of PDE Toolbox of Matlab® such as maximum edge size, growth rate and PDE Toolbox of Matlab® grid generator. The block 12 calls FE-solver of PDE Toolbox for finding the first finite element approximation, step B.

Block 14 is optional for finding the error (brute force method) if the user has time enough and computer resources for it.

Block 16 is used to construct the second mesh and find the second finite element approximation for the adjoint problem, step C. It calls PDE Toolbox of Matlab® grid generator and its FE-solver for refining the second mesh in the zone of interest and also globally in the whole solution domain and computing the second approximation, step D.

Blocks 12, 14, and 16 have special fields, where the parameters of corresponding meshes such as number of triangles and number of nodes are displayed.

Block 18 is designed to compute the estimator (E), step E. There is a possibility of choosing the type of gradient averaging and a parameter for calculating the integrals in the estimator (E), the number of triangles in the mesh used to calculate the estimator is shown in a special field. Steps 5-9 of paragraph B.9 form step E here.

Block 20 is a table designed to show the results of calculations and values of different parameters used in the processes of calculations. If user considers an error being too large, he or she can recomputed with changed initial parameters (STEP F1 or F2).

Referring now to FIG. 5, the solution domain and the zone of interest are set defining their geometry on the desktop of the PDE Toolbox. The coefficients and the source function are set in a known manner with the PDE Toolbox's facilities by using its panel buttons or drop menus.

The solution domain presents here a thin plate, which is heated overall by a constant heat source (f=10 everywhere). The material of the plate is assumed to be homogeneous so that we can take the diagonal diffusion coefficients to be equal to 1, and the off-diagonal coefficients to be equal to 0. For simplicity, we assume that we have homogeneous Dirichlet boundary condition only, i.e., the temperature is assumed to be zero over the boundary of the plate. The temperature distribution in this plate can be described then by the following BVP

$$- \frac{{\partial }^{2} u}{\partial {x}_{1}^{2}} - \frac{{\partial }^{2} u}{\partial {x}_{2}^{2}} = 10 in Ω ,$$

The knowledge of the temperature, especially at some critical areas, is very important for making the right design solutions, which can save, e.g., material resources or help to improve the geometry of the plate. In the domains like we are dealing with now which have concavity in the boundary, such critical area is neighbourhood of concavity point, which dictated our choice of the zone of interest.

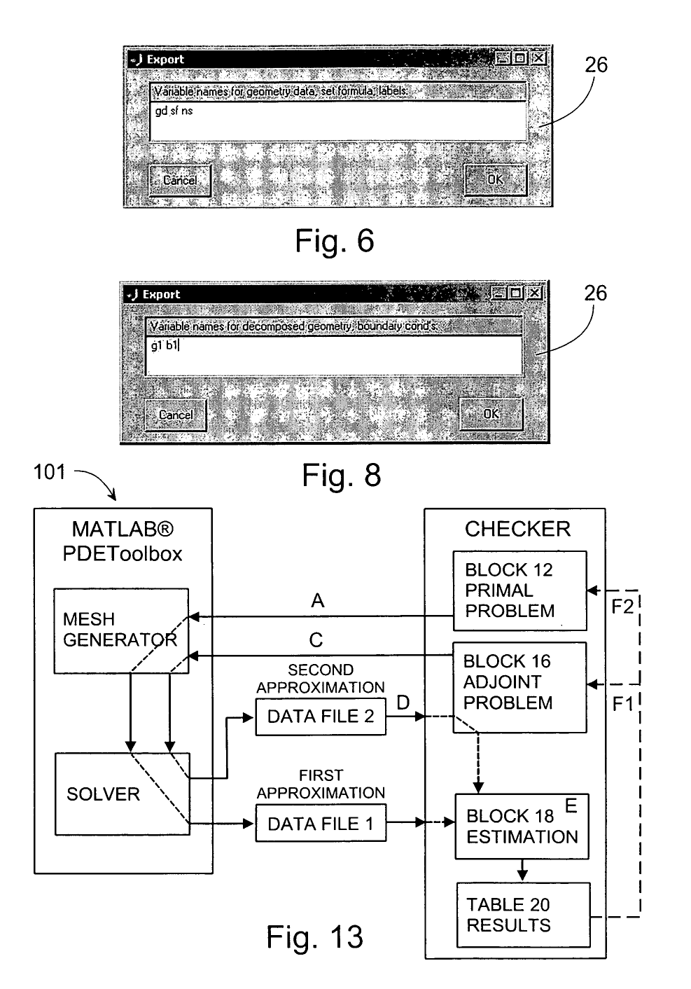

After the setting of the problem, all the date of the problem are exported to our software, FIG. 6 shows PDE Toolbox's export window 26. Parameters gd refers to “geometry data”, sf refers to “set formula”, and ns refers to “labels”

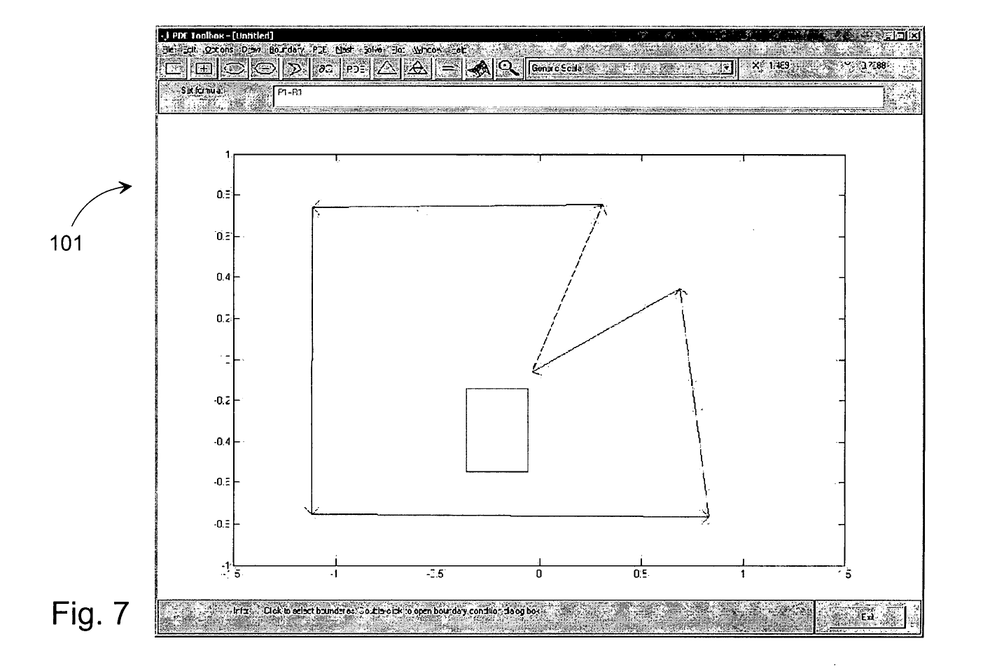

FIG. 7 presents setting the boundary conditions using the Matlab® PDE Toolbox's means.

FIG. 8 presents exporting the decomposed geometry and boundary conditions to CHECKER software using the export window 26.

The export functions used in FIGS. 6 and 8 are provided by Matlab® PDE Toolbox.

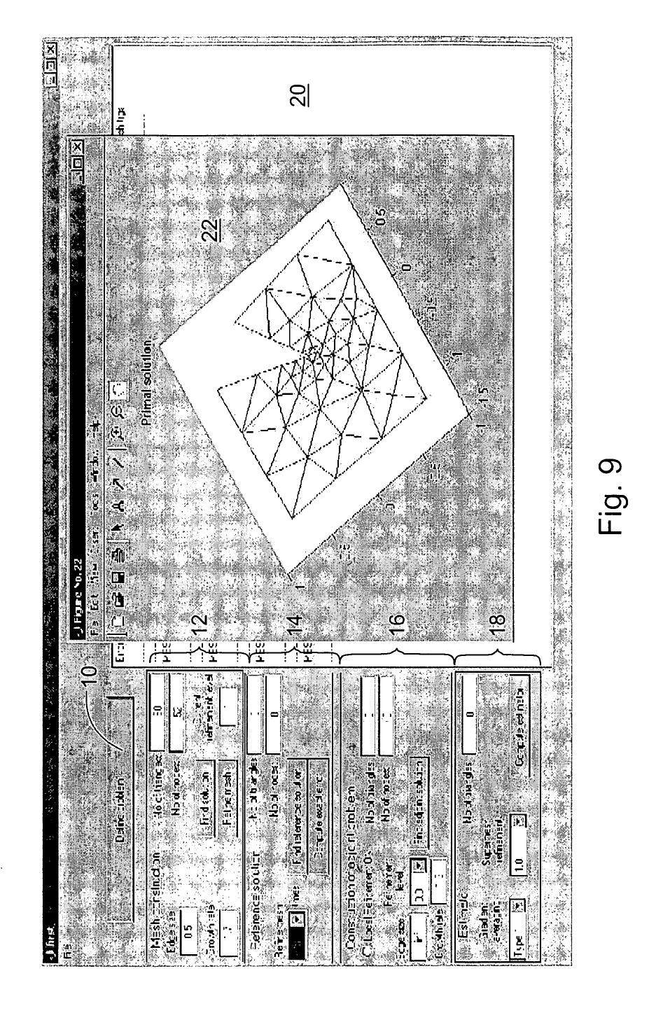

After the previously defined data have been exported to the CHECKER software, the first finite element approximation (Primal Solution) is calculated using Block 12. The result of calculations is shown in a new popup window 22, which presents the 3D visualization of the approximate solution. The used mesh can be obtained (see FIG. 9) by rotating the 3D visualization.

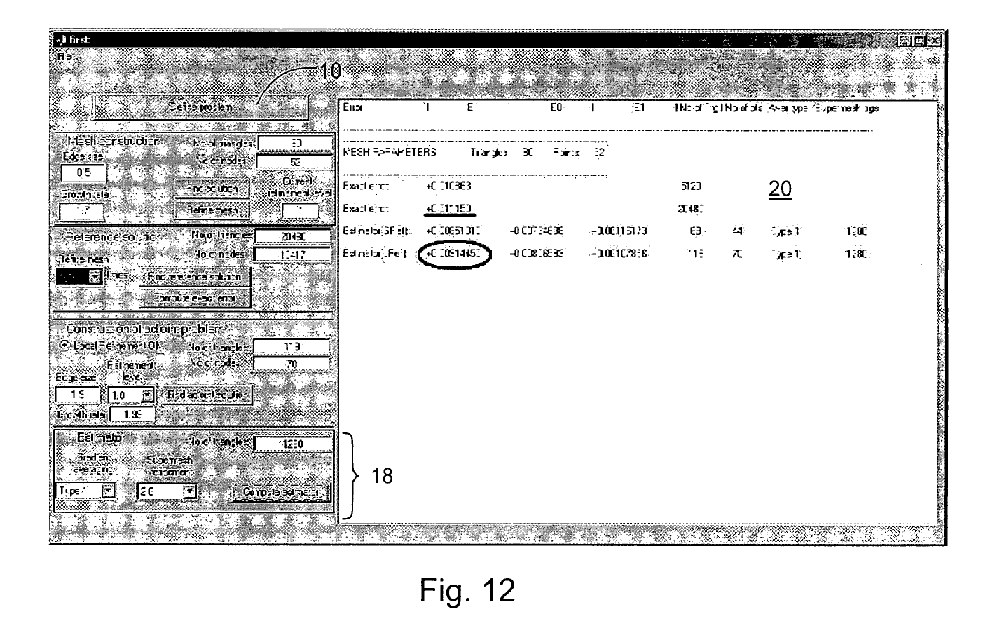

Block 14 by brute force method computes the reference solution on very fine mesh and tries to find the exact value of the problem-oriented criterion. This brute force method is not advisable for using in the engineering practice since it takes a large amount of computational time and memory. The brute force methods may require 100 times computer resources (processor speed, processing time and memory) as the new method herein described. The reference solution here is computed only for an illustration of the invention as it gives a more or less reliable reference result. The results of performance of Block 14 are shown in Table 20 in FIG. 12 (“exact error”). Ordinary user does not need Block 14.

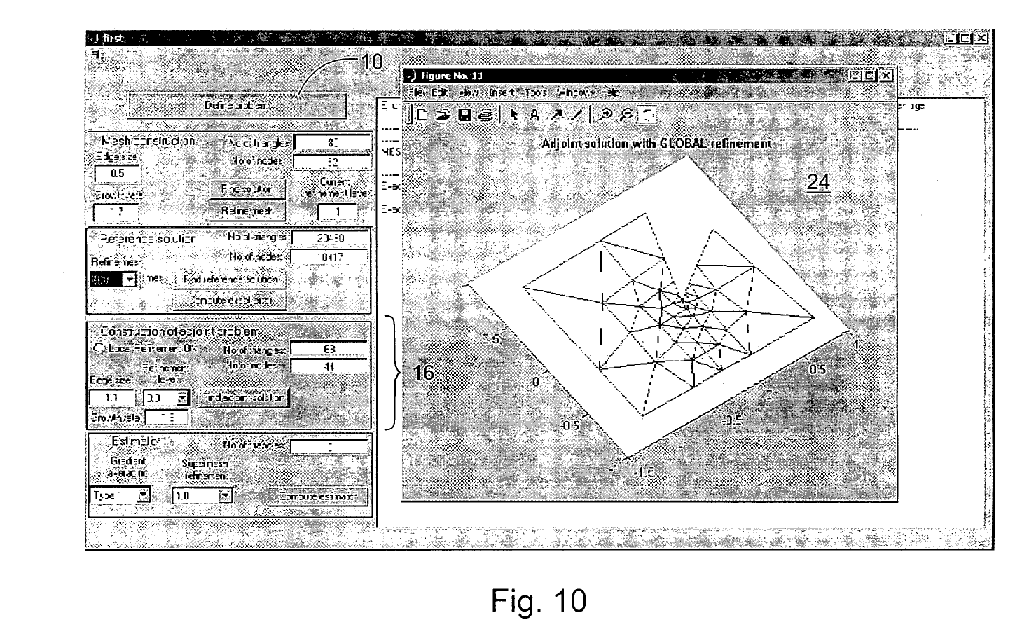

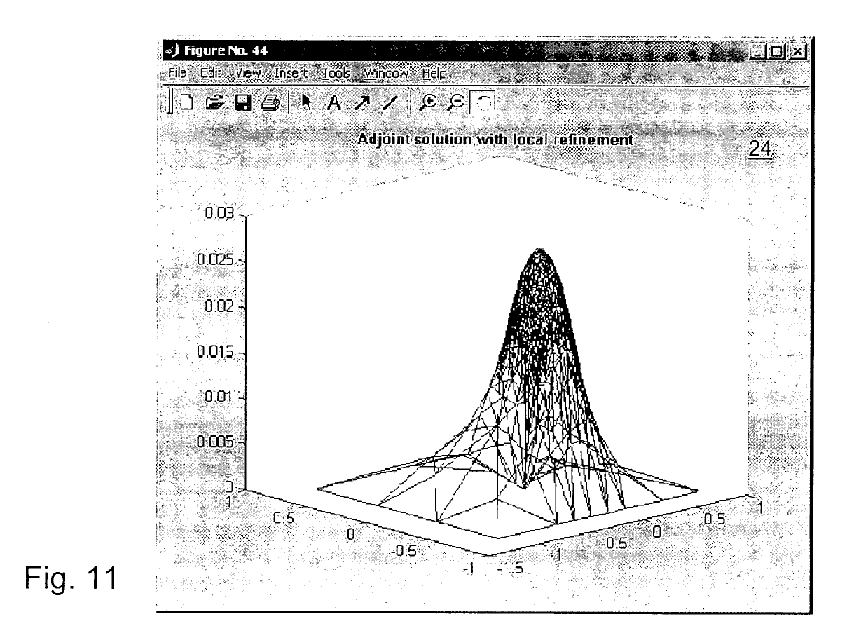

Block 16 constructs the adjoint mesh and solves the adjoint problem (with PDE Toolbox). In the present implementation the function (ù) in the adjoint problem is set by default to 1 in the zone of interest and zero outside of it. Further implementation will make it possible to set the function (ù) arbitrarily, which can help to analyse critical areas more carefully. FIG. 10 shows the results of calculations of the adjoint problem in a new pop-up window 24 similarly to FIG. 9. In Block 16 we have also a possibility to construct another adjoint mesh condensed in the zone of interest and make new calculations, which is shown in 3D visualization in FIG. 11.

After putting window 24 to the background we can make visible the table 20 with the results of all previous calculations (FIG. 12).

All the blocks compute all the approximate solutions and the estimator using formulas as described above. Block 12 computes the first finite element approximation. Block 16 computes the second finite element approximation (for the adjoint/auxiliary problem). Block 18 computes the value of the estimator using the invented formula.

After getting the result user is able to consider if the estimator shows that the first approximation isn't enough accurate, he/she can change initial parameters and recompute a new approximation and a new estimator.

### III Model Example—One Dimensional Case

The model depicts a heated rod, which is insulated but heated on its length. The rods ends are kept in zero temperature. The heating is defined by the source function. The designer gets advantage when he/she is able to compute temperature distribution more accurately and computationally cheaper in critical area.

We begin with forming a simple problem: find the function u such that

−u\ddot{}(x)=f(x) in Ω=(0,1), (1)

u(0)=u(1)=0, (2)

where

$$f ( x ) = \{ \begin{matrix}2 α & exp ( \frac{1}{{s}^{2}} - \frac{1}{p} ) \cdot [ - 2 {( x - {x}_{0} )}^{2} + 4 {p ( x - {x}_{0} )}^{2} + {p}^{2} ] \cdot \frac{1}{{p}^{4}} , \\ & if x ∈ ( a , b ) ⋐ ( 0 , 1 ) , \\ 0 , & otherwise ,\end{matrix}$$

p=s²−(x−x₀)², s=½(b−a), x₀=½(a+b), and α is a positive real number.) Here a, b are coordinates of two sides of the rod. f(x) is a function that has a meaning of “heating function”. It shows t he amount of heat given to each elementary part of the rod. x is a coordinate changing along the rod, x₀ is a central point inside (a,b). s, p, and α: are positive parameters that define the shape of f(x). It should be noted that such a form of “f” is taken only for a particular example. u(x) has a meaning of the temperature of the rod at point x

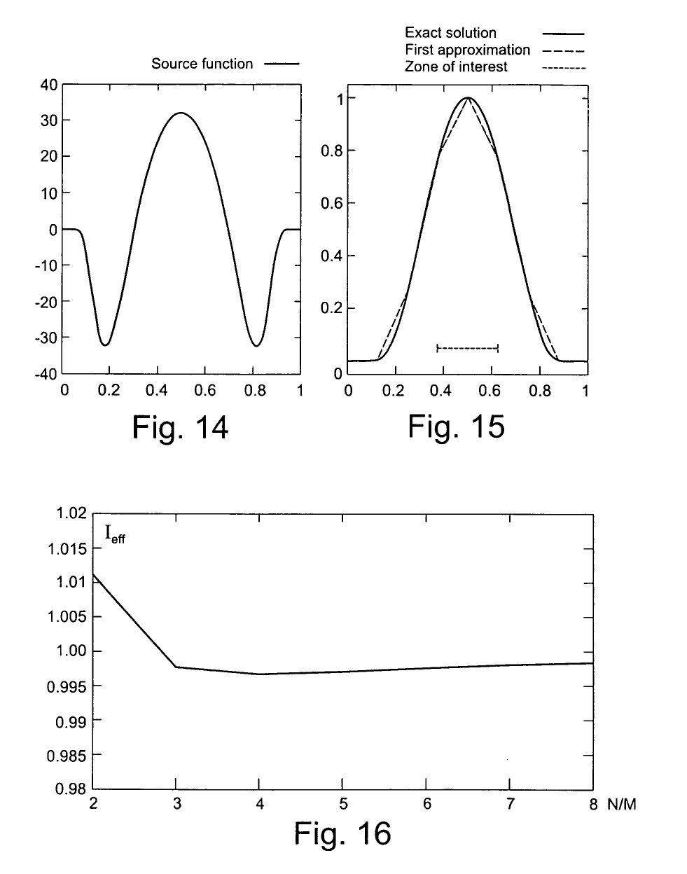

FIG. 14 presents the shape of the source function. The exact solution of problem (1)-(2) is

$$u ( x ) = \{ \begin{matrix}α \cdot exp ( \frac{1}{{s}^{2}} - \frac{1}{p} ) , & if x ∈ ( a , b ) ⋐ ( 0 , 1 ) , \\ 0 , & otherwise .\end{matrix}$$

The exact and approximate solutions of problem (1)-(2) (full line) and the zone of interest (dotted line) are marked in FIG. 15.

As a quantity of interest, we take the following integral

$${\int }_{0}^{1} ϕ ( x ) ( u ( x ) - {u}_{h} ( x ) ) ⅆ x , \\ where \\ ϕ ( x ) = \{ \begin{matrix}1 , & if x ∈ ( {z}_{1} , {z}_{2} ) \\ 0 , & otherwise .\end{matrix} \qquad ( 3 )$$

where

In what follows, M denotes the number of elements in the mesh for the primal problem, N stands for the number of elements in the mesh used for the corresponding adjoint problem. In all the tests below, M=8, a=0, b=1.0, and α=1.0.

1. Adjoint Problem is Solved on Uniformly Refined Meshes

First, we present the results of numerical experiments where the uniform meshes are used, i.e., h=1/M and τ=1/N.

### EXAMPLE 1

In this series of numerical tests, (z₁,z₂)=(0.375,0.625) (cf. FIG. 15).

In Table I, we present the numerical results for problem (1)-(2) with M=8 and N=k·M, k=2,3,4,5,6,7,8.

TABLE I
The results of performance of the estimator E for Example 1.

| M | N | E₀ | E₁ | E | criterion | I_{eff} |
|---|---|---|---|---|---|---|
| 8 | 16 | 0.00693883 | 0.00238174 | 0.00932058 | 0.00921705 | 1.01123239 |
| 8 | 24 | 0.00820668 | 0.00098981 | 0.00919649 | 0.00921705 | 0.99776967 |
| 8 | 32 | 0.00864915 | 0.00053743 | 0.00918658 | 0.00921705 | 0.99669427 |
| 8 | 40 | 0.00885372 | 0.00033653 | 0.00919025 | 0.00921705 | 0.99709278 |
| 8 | 48 | 0.00896479 | 0.00023026 | 0.00919505 | 0.00921705 | 0.99761349 |
| 8 | 56 | 0.00903174 | 0.00016737 | 0.00919911 | 0.00921705 | 0.99805336 |
| 8 | 64 | 0.00907518 | 0.00012710 | 0.00920229 | 0.00921705 | 0.99839820 |

The last column of the table presents the so-called “effectivity index”, which is often used to give a normalized measure of the quantity of error estimation. In our case, this index is computed as follows:

$${I}_{eff} = \frac{\vert E ( {u}_{h} , {v}_{τ} ) \vert}{\vert {\int }_{0}^{1} ϕ ( x ) ( u ( x ) - {u}_{h} ( x ) ) ⅆ x \vert} \qquad ( 4 )$$

The dependence of I_{eff} on the number k is presented on FIG. 16. It is easy to see that the estimator E works quite well even for very modest values of N.

2. Adjoint Problem is Solved on Condensed Meshes

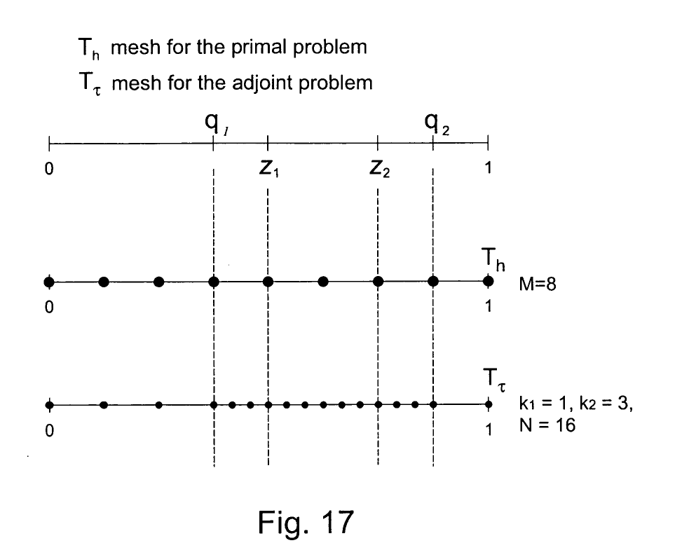

In this subsection, we present the results of numerical experiments, where the mesh used for solving the adjoint problem is condensed around the “zone of interest” (z₁,z₂). As before, h=1/M . Now, we are aimed to show that to have a good quality of the error estimation it is not necessarily required to also use globally refined meshes for the adjoint problem. We find that essentially the same result can be obtained on the mesh refined only in the “zone of interest” (i.e., we have less degrees of freedom and, thus, save computational costs). Thus, in the tests of Example 2, the mesh T_{τ} is only refined in a certain interval (q₁,q₂) that contains (z₁,z₂). To numerically qualify the respective meshes, we introduce positive numbers Mᵢ,i=1,2,3, that correspond to the number of elements in the mesh for the primal problem in the intervals (0,q₁), (q₁,q₂), and (q₂,1.0), respectively. The numbers of elements in the mesh used for the adjoint problem in the intervals (0,q₁), (q₁,q₂), and (q₂,1.0) are defined in terms of two positive numbers k₁ and k₂ as follows—M₁·k₁, M₂·k₂, and M₃·k₁, respectively. Thus, the density of the mesh used for the adjoint problem with respect to the mesh used for the primal problem inside the interval (q₁,q₂) is given by k₂, and outside of the interval (q₁,q₂)—by k₁. Evidently, the total number of elements in the mesh used for the adjoint problem is given by N=M₁·k₁+M₂·k₂+M₃·k₁, see FIG. 17, showing meshes Tₕ and T_{τ} used for problem (1)-(2).

### EXAMPLE 2

### We take (z₁,z₂)=(0.500,0.750) and (q₁,q₂)=(0.375,0.875). The results of the tests for various values of kᵢ are presented in Table II.

TABLE II
The results of performance of the estimator E for
Example 2.

| M₁ | M₂ | M₃ | k₁ | k₂ | M | N E | criterion | I_{eff} |
|---|---|---|---|---|---|---|---|---|
| 3 | 4 | 1 | 3 | 3 | 8 | 24 0.00495048 | 0.00500423 | 0.98925780 |
| 3 | 4 | 1 | 2 | 3 | 8 | 20 0.00495048 | 0.00500423 | 0.98925777 |
| 3 | 4 | 1 | 1 | 3 | 8 | 16 0.00495048 | 0.00500423 | 0.98925773 |
| 3 | 4 | 1 | 1 | 2 | 8 | 12 0.00493566 | 0.00500423 | 0.98629572 |
| 6 | 8 | 2 | 3 | 3 | 16 | 48 0.00122594 | 0.00122749 | 0.99873983 |
| 6 | 8 | 2 | 2 | 3 | 16 | 40 0.00122594 | 0.00122749 | 0.99873972 |
| 6 | 8 | 2 | 1 | 3 | 16 | 32 0.00122594 | 0.00122749 | 0.99873956 |
| 6 | 8 | 2 | 1 | 2 | 16 | 24 0.00123056 | 0.00122749 | 1.00249939 |

We see that the quality of the error estimation remains quite good even if

$$\frac{M}{N} = 1.5 ,$$

what shows the effectivity of local mesh refinement in the “zone of interest”.

Referring now to FIG. 12 to the results exposed in the table 20 we clearly observe good performance of the estimator for two dimensional problems. The “exact error” is based on the reference solution computed by brute force method used instead of the exact solution. The “exact error” means the relevant quantity of interest computed by the same formula (4) as presented paragraph B.3.

In the above examples the models depict diffusion type processes, which arise often in various engineering applications. A typical diffusion process is heat propagation inside a body. So that physically our examples can be considered as problems on the distribution of a heat inside a body with given temperature at the boundary and a certain distribution (f) of the heat source. It is worth outlining that the algorithm suggested is applicable not only to such type of problems, but for all other physical models that can be described in terms of linear elliptic equations (e.g., linear elasticity, electrostatic problems, certain models in the theory of plates and shells). We refer to diffusion type problems as to a simple and transparent example.

### REFERENCES

[1]. Babu\check{s}ka, T. Strouboulis. The Finite Element Method and its Reliability, Oxford University Press Inc., New York, 2001.

[2] R. Becker, R. Rannacher. A feed-back approach to error control in finite element methods: Basic approach and examples. East-West J. Numer. Math., 4, 237-264, 1996.

[3] S. Korotov, P. Neittaanmäki, S. Repin. A posteriori error estimation of goal-oriented quantities by the superconvergence patch recovery. J. Numer. Math. 11, 33-59, 2003.

[4] J. T. Oden, S. Prudhomme. Goal-oriented error estimation and adaptivity for the finite element method. Comput. Math. Appl., 41, 735-756, 2001.

[5] R. Verfurth. A review of a posteriori error estimation and adaptive mesh-refinement techniques), Wiley-Teubner, 1996.

1. Method for verification of the accuracy of numerical data measured in terms of given problem-oriented criteria, where the numerical data are computed in the process of solution of a boundary value problem, which is defined by one or several partial differential equations (PDEs), governing an unknown physical quantity (u) in a solution domain, and containing a set of given coefficients, describing physical properties the media, and a given source function (f), and two types of boundary conditions, where the first type, called the Dirichlet boundary condition, prescribes a behaviour of the physical quantity (u) on the first part of a boundary of the solution domain, called the Dirichlet boundary (Γ₁), by a given function (u₀), and the second type, called the Neumann boundary condition, prescribes a behaviour of partial derivatives of the physical quantity (u) on the second part of the boundary of the solution domain, called the Neumann boundary (Γ₂) by a given boundary function (g), and where the Dirichlet boundary and the Neumann boundary do not intersect and their union forms the solution domain boundary (Γ) containing steps of
a) forming a primal problem and finding its finite element approximation, called as the first approximation (uₕ), using a standard finite element mesh, called as the first mesh (Tₕ), and the first set of basic functions (wₕ), thus obtaining said numerical data, and
b) defining a problem-oriented criterion by choosing a zone of interest (ω) in the solution domain (Ω) and a weight function (φ) defined in the zone of interest, and
c) forming an auxiliary problem, using the zone of interest (ω) and the weight function (φ), and finding its finite element approximation, called as the second approximation (v_{τ}), using another standard finite element mesh, called as the second mesh (T_{τ}), non-coinciding with the first mesh (Tₕ), and the second set of basic functions (w_{τ}), obtaining the second set of numerical data, and then
d) computing an estimator (E) for the problem-oriented criterion using the given data, the said data and the second set of data.

2. Method according to claim 1, characterized in that the estimator (E) is a sum of the first term (E₀) and the second term (E₁), where
a) the first term (E₀) is computable as a sum of three parts, where the first part is an integral over the solution domain (Ω) of a product of the source function (f) and the second approximation (v_{τ}), the second part is an integral over the Neumann boundary (Γ₂) of a product of the boundary function (g) and the second approximation (v_{τ}), and the third part is a minus integral over the solution domain (Ω) of an energy scalar products of the gradients of the first (uₕ) and the second (v_{τ}) approximations, and
b) the second term (E₁) is the integral over the solution domain (Ω) of the energy scalar product of two vector-functions, where the first vector-function is the difference between the gradient of the first approximation (uₕ) and the averaged gradient of the first approximation (uₕ), and the second vector-function is the difference between the gradient of the second approximation (v_{τ}) and the averaged gradient of the second approximation (v_{τ}).

3. Method according to claim 1 or 2, characterized in that the second mesh (T_{τ}) is condenced in the zone of interest.

4. Method according to claim 1, characterized in that the first and the second (v_{τ}) approximations are of the Galerkin type.

5. Method according to claim 2, characterized in that the boundary-value problem describes a physical process in a form
$$- {\sum }_{i , j = 1}^{d} \frac{\partial }{\partial {x}_{i}} ( {a}_{ij} \frac{\partial u}{\partial {x}_{j}} ) = f in Ω , \qquad ( 1 )$$
u=u₀ on Γ₁, (2)
$${\sum }_{i , j = 1}^{d} {a}_{ij} \frac{\partial u}{\partial {x}_{j}} {n}_{i} = g on {Γ}_{2} . \qquad ( 3 )$$
where relation (1) is a process governing equation in the solution domain (Ω), where aᵢⱼ₌ₐᵢⱼ(x₁, . . . ,x_{d}),i,j=1, . . . ,d, are the given coefficients, which are bounded functions, describing physical properties of the respective media, f=f(x₁, . . . ,x_{d}) is the source function, which is a square summable function, and where relation (2) is the Dirichlet boundary condition, and the boundary function u₀=u₀(x₁, . . . ,x_{d}) belongs to a natural energy class of the problem, and where relation (3) is the Neumann boundary condition, and the boundary function g=g(x₁, . . . ,x_{d}) is a square summable function, and symbol nᵢ denotes the i-th component of the outward normal vector n=n(x₁, . . . ,x_{d}) to the boundary Γ, i.e., n=[n₁, . . . ,n_{d}]^{T}, and the first approximation (uₕ) is defined as a function uₕ=uₕ(x₁, . . . ,x_{d})εVₕ+u₀, such that
$${\int }_{Ω} {\sum }_{i , j = 1}^{d} {a}_{ij} \frac{\partial {u}_{h}}{\partial {x}_{j}} \frac{\partial {w}_{h}}{\partial {x}_{i}} ⅆ x = {\int }_{Ω} {fw}_{h} ⅆ x + {\int }_{{Γ}_{2}} {gw}_{h} ⅆ s ∀ {w}_{h} ∈ {V}_{h} ,$$
where Vₕ is the first finite-dimensional space constructed by means of standard basis functions (wₕ), which vanish on the Dirichlet boundary (Γ₁), and the problem-oriented criterion is presented by the integral
$${\int }_{Ω} ϕ ( u - {u}_{h} ) ⅆ x , \qquad ( 4 )$$
where φ=φ(x₁, . . . ,x_{d}) is a weight function vanishing outside of the zone of interest (ω), and the second approximation (v_{τ}) is defined as a function v_{τ}=v_{τ}(x₁, . . . ,x_{d})εV_{τ}, such that
$${\int }_{Ω} {\sum }_{i , j = 1}^{d} {a}_{ji} \frac{\partial {v}_{τ}}{\partial {x}_{j}} \frac{\partial {w}_{τ}}{\partial {x}_{i}} ⅆ x = {\int }_{Ω} ϕ {w}_{τ} ⅆ x ∀ {w}_{τ} ∈ {V}_{τ} ,$$
where V_{τ} is the second finite-dimensional space constructed by means of standard basis functions (w_{τ}), which vanish on the boundary Γ,
and where the problem-oriented criterion (4) is estimated by the estimator E(uₕ,v_{τ}) given by the following formula:
E(uₕ,v_{τ})=E₀(uₕ,v_{τ})+E₁(uₕ,v_{τ}),
where
$${E}_{0} ( {u}_{h} , {v}_{τ} ) = {\int }_{Ω} {fv}_{τ} ⅆ x + {\int }_{{Γ}_{2}} {gv}_{τ} ⅆ s - {\int }_{Ω} {\sum }_{i , j = 1}^{d} {a}_{ij} \frac{\partial {u}_{h}}{\partial {x}_{j}} \frac{\partial {v}_{τ}}{\partial {x}_{i}} ⅆ x , \\ and$$
$${E}_{1} ( {u}_{h} , {v}_{τ} ) = {\int }_{Ω} {\sum }_{i , j = 1}^{d} {a}_{ij} ( \frac{\partial {u}_{h}}{\partial {x}_{j}} - {G}_{h}^{j} ( ∇ {u}_{h} ) ) ( \frac{\partial {v}_{τ}}{\partial {x}_{j}} - {G}_{τ}^{i} ( ∇ {v}_{τ} ) ) ⅆ x ,$$
where
$$\frac{\partial {u}_{h}}{\partial {x}_{1}} , ⋯ , \frac{\partial {u}_{h}}{\partial {x}_{d}}$$
are the components of the gradient
$$∇ {u}_{h} = {[ \frac{\partial {u}_{h}}{\partial {x}_{1}} , ⋯ , \frac{\partial {u}_{h}}{\partial {x}_{d}} ]}^{T} ,$$
of the first approximation (uₕ) and
$$\frac{\partial {v}_{τ}}{\partial {x}_{1}} , ⋯ , \frac{\partial {v}_{τ}}{\partial {x}_{d}}$$
are the components of the gradient
$$∇ {v}_{τ} = {[ \frac{\partial {v}_{τ}}{\partial {x}_{1}} , ⋯ , \frac{\partial {v}_{τ}}{\partial {x}_{d}} ]}^{T}$$
of the second approximation (v_{τ}), and Gₕ¹(∇uₕ), . . . ,Gₕ^{d}(∇uₕ) are the components of the averaged gradient Gₕ(∇uₕ)=[Gₕ¹(∇uₕ), . . . ,Gₕ^{d}(∇uₕ]^{T}, which is obtained by mapping the gradient ∇uₕ, which is constant over each element of the first mesh (Tₕ), into a vector-valued continuous piecewise affine function (Gₕ(∇uₕ)) by setting each its nodal value in the first mesh (Tₕ) as the mean value of ∇uₕ on all elements of the patch (P(xₒ)) associated with a corresponding node (xₒ), and where G_{τ}¹(∇v_{τ}), . . . ,G_{τ}^{d}(∇v_{τ}) are the components of the averaged gradient G_{τ}(∇v_{τ})=[G_{τ}¹(∇v_{τ}), . . . ,G_{τ}^{d}(∇v_{τ}]^{T}, which is obtained by mapping the gradient ∇v_{τ}, which is constant over each element of the second mesh (T_{τ}), into a vector-valued continuous piecewise affine function G_{τ}(∇v_{τ}) by setting each its nodal value in the second mesh (T_{τ}) as the mean value of ∇v_{τ} on all elements of the patch (P(xₒ)) associated with a corresponding node (xₒ).

6. Method according to claim 2, characterized in that the boundary value problem describes a mechanical problem for a solid body, made of linear elastic media, consisting of finding a vector-function (u), which represents a displacement field in the solid body (Ω), as follows
$$- {\sum }_{j , k , l = 1}^{d} \frac{\partial }{\partial {x}_{j}} ( {L}_{ijkl} {ϵ}_{kl} ( u ) ) = {f}_{i} in Ω , \qquad ( 1 )$$
uᵢ=u₀ⁱ Γ₁, (2)
$${\sum }_{j , k , l = 1}^{d} {n}_{j} {L}_{ijkl} {ϵ}_{kl} ( u ) = {g}_{i} on {Γ}_{2} , \qquad ( 3 )$$
where relation (1) is an equilibrium equation in the solution domain (Ω), where Lᵢⱼₖₗ=Lᵢⱼₖₗ(x₁, . . . ,x_{d}),i,j=1, . . . ,d, are the given coefficients, which are bounded functions, describing elastic properties of the respective body, and satisfy the following symmetry conditions Lⱼᵢₖₗ=Lᵢⱼₖₗ=Lₖₗᵢⱼ, i, j, k, l=1, . . . ,d, and f=f(x₁, . . . ,x)=[f₁, . . . ,f_{d}^{T}] is the source vector-function, describing a body force, which is a square summable function, and functions εᵢⱼ(u),i j=1, . . . ,d, are defined as follows
$${ϵ}_{ij} ( u ) = \frac{1}{2} ( \frac{\partial {u}_{i}}{\partial {x}_{j}} + \frac{\partial {u}_{j}}{\partial {x}_{i}} ) ,$$
and where relation (2) is the Dirichlet boundary condition, and the boundary vector-function u₀=u₀(x₁, . . . ,x_{d})=[u₀¹, . . . ,u₀^{d}]^{T} belongs to the natural energy class of the problem, and relation (3) is the Neumann boundary condition, and the boundary vector-function g=g(x₁, . . . ,x_{d})=[g₁. . . ,g_{d}]^{T} is a square summable function, describing an external force, and symbol nᵢ denotes the i-th component of the outward normal vector n=n(x₁, . . . ,x_{d}) to the boundary Γ, and the first approximation (uₕ) is defined as a vector-function
uₕ=uₕ(x₁, . . . ,x_{d})=[uₕ¹, . . . ,uₕ^{d}]^{T}δVₕ+u₀,
such that
$${\int }_{Ω} {\sum }_{i , j , k , l = 1}^{d} {L}_{ijkl} {ϵ}_{ij} ( {u}_{h} ) {ϵ}_{kl} ( {w}_{h} ) ⅆ x = {\int }_{Ω} f • {w}_{h} ⅆ x + {\int }_{{Γ}_{2}} g • {w}_{h} ⅆ s ∀ {w}_{h} ∈ {V}_{h} ,$$
where (Vₕ) is the first finite-dimensional space constructed by means of standard basis vector-function (wₕ) which vanish on the Dirichlet boundary δ₁,
and the problem-oriented criterion is presented by the integral
$${\int }_{Ω} Φ • ( u - {u}_{h} ) ⅆ x , \qquad ( 4 )$$
where Φ=Φ(x₁, . . . ,x_{d})=[φ₁, . . . ,φ_{d}]^{T} is a weight vector-function vanishing outside of the zone of interest (ω), and the second approximation (v_{τ}) is defined as a vector-function
v_{τ}=v_{τ}(x₁, . . . ,x_{d})εV_{τ}, such that
$${\int }_{Ω} {\sum }_{i , j , k , l = 1}^{d} {L}_{ijkl} {ϵ}_{ij} ( {𝓋}_{r} ) {ϵ}_{kl} ( {w}_{τ} ) ⅆ x = {\int }_{Ω} Φ • {w}_{τ} ⅆ x ∀ {w}_{τ} ∈ {V}_{τ} ,$$
where (V_{τ}) is the second finite-dimensional space constructed by means of the standard basis vector-functions (w_{τ}), which vanish on the boundary Γ, and where the problem-oriented criterion (4) is estimated by the estimator E(uₕ,v_{τ}) given by the following formula:
E(uₕ,v_{τ})=E₀(uₕ, . . . ,v_{τ})+E₁(uₕ, . . . ,v_{τ}),
where
$${E}_{0} ( {u}_{h} , {𝓋}_{τ} ) = {\int }_{Ω} f {•𝓋}_{τ} ⅆ x + {\int }_{{Γ}_{2}} g • {𝓋}_{τ} ⅆ s - {\int }_{Ω} {\sum }_{i , j , k , l = 1}^{d} {L}_{ijkl} {ϵ}_{ij} ( {u}_{h} ) {ϵ}_{kl} ( {𝓋}_{τ} ) ⅆ x , \\ and$$
$${E}_{1} ( {u}_{h} , {𝓋}_{τ} ) = {\int }_{Ω} {\sum }_{i , j , k , l = 1}^{d} {L}_{ijkl} ( {ϵ}_{ij} ( {u}_{h} ) - {G}_{h}^{i , j} ( ϵ ( {u}_{h} ) ) ) ( {ϵ}_{kl} ( {𝓋}_{τ} ) - {G}_{τ}^{k , l} ( ϵ ( {𝓋}_{τ} ) ) ) ⅆ x ,$$
where εᵢⱼ(uₕ) is a (i,j) entry of the tensor (d×d matrix) of the first approximation uₕ, defined as
$$ϵ ( {u}_{h} ) = {[ \frac{1}{2} ( \frac{\partial {u}_{h}^{i}}{\partial {x}_{j}} + \frac{\partial {u}_{h}^{j}}{\partial {x}_{i}} ) ]}_{i , j = 1}^{d} , {ϵ}_{kl} ( {𝓋}_{τ} )$$
εₖₗ(v_{τ}) is a (k,l) entry of the tensor (d×d matrix) of the second approximation (v_{τ}), defined as
$$ϵ ( {𝓋}_{τ} ) = {[ \frac{1}{2} ( \frac{\partial {v}_{τ}^{i}}{\partial {x}_{j}} + \frac{\partial {𝓋}_{τ}^{j}}{\partial {x}_{i}} ) ]}_{i , j = 1}^{d} , and {G}_{h}^{i , j} ( ϵ ( {u}_{h} ) )$$
and Gₕ^{i,j}(ε(uₕ)) is a (i,j) entry a d×d matrix-valued continuous piecewise affine function Gₕ(ε(uₕ))=[Gₕ^{i,j}(ε(uₕ))]_{i,j=1}^{d}, which is obtained from the tensor (ε(uₕ)), which is a constant d×d matrix over each element of the first mesh, by setting each its nodal value as the mean value of (ε(uₕ)) on all elements of the patch (P(xₒ)) in the first mesh (Tₕ) associated with corresponding node (xₒ), and G_{τ}^{k,j}(ε(v_{τ})) is a (k,l) entry of a d×d matrix-valued continuous piecewise affine function G_{τ}(ε(v_{τ}))=[G_{τ}^{i,j}(ε(v_{τ}))]_{i,j=1}^{d}, which is obtained from the tensor ((ε(v_{τ})), which is a constant d×d matrix over each element of the second mesh, by setting each its nodal value as the mean value of the tensor (δ(v_{τ})) on all elements of the patch (P(xₒ)) in the second mesh (T_{τ}), associated with corresponding node (xₒ).

7. Method for verification of the accuracy of numerical data on a digital computer, said digital computer comprising at least one central processing unit, memory, an input device and an output device, and where the numerical data are computed using finite element method (FEM) and in the process of solution of a boundary value problem (BVP), called as a primal problem, as the first approximation and BVP comprising at least one partial differential equation (PDE), a set of given coefficients, a given source function, and boundary conditions, the method comprising;
setting data defining said BVP into the memory;
setting the first parameters for a mesh, called the first mesh, into the memory;
computing the first approximation and obtaining said numerical data and saving this data into the memory;
selecting the parameters of a second mesh, and the parameters of the quantity of interest these forming an auxiliary problem with the PDE and saving these parameters into the memory;
computing the solution of the auxiliary problem and thus obtaining the second approximation and saving it into the memory as the second numerical data;
computing an error estimator using the set data, the first numerical data and second numerical data and presenting the computed estimator using the output device.

8. Method according to claim 7, characterized in that a graphical user interface (GUI) is used to control the setting steps and computing steps.

9. Method according to claim 7, characterized in that a separate software is formed having an interface with an existing FEM-software used for generating at least one mesh and for computing at least one approximation.

10. Method according to claim 7, characterized in that the output device includes a display.

11. Method according to claim 7, characterized in that at least one mesh is formed using a grid generator.

12. Method according to claim 7, characterized in that at least one approximation is computed using a FE-solver.

13. Method according to claim 7, characterized in that a reference solution is computed using a brute force method for testing the method.

14. Method according to claim 8, characterized in that the GUI is provided with control blocks for setting data for the primal and auxiliary problems.

15. Method according to claim 8, characterized in that the GUI is provided with a table for showing the result.

16. Method according to claim 7, characterized in that a gradient of the first approximation, an averaged gradient of the first approximation, a gradient of the second approximation and an averaged gradient of the second approximation are computed, when computing the error estimator.

17. Method according to claim 7, characterized in that a new set of parameters for at least one mesh is selected after the result is displayed and a new result is recomputed.

18. Method according to claim 7, characterized in that at least one new result is computed using another given source function.

19. A digital computer system programmed to perform method of claim 7.

20. A computer-readable medium storing computer program implementing the method of claim 7.
